(19) United States
(12) Patent Application Publication
(10) Pub. No.: US 2001/0026349 A1
(43) Pub. Date: Oct. 4, 2001

(54) Method and apparatus for manufacturing liquid crystal panel

(76) Inventors: Keiichi Furukawa, Suita-Shi (JP); Masakazu Okada, Kyoto-Shi (JP); Jun Yamada, Takatsuki (JP); Ken Matsuoka, Amagasaki-Shi (JP); Tatsuo Taniguchi, Hashimoto-Shi (JP); Masahide Ueda, Kashihara-Shi (JP); Mitsuyoshi Miyai, Sakai-Shi (JP)

Correspondence Address: SIDLEY AUSTIN BROWN & WOOD, 717 NORTH HARWOOD, SUITE 3400, DALLAS, TX, 75201, US

(21) Appl. No.: 09/821,941

(22) Filed: Mar. 30, 2001

(30) Foreign Application Priority Data
Mar. 31, 2000 (JP) 2000-96676
Mar. 31, 2000 (JP) 2000-97523

(51) Int. Cl. G02F 1/13

(52) U.S. Cl. 349/187

(57) ABSTRACT

A liquid crystal panel is manufactured through several steps. First and second substrates are positioned on first and second stages and then preheated to a certain temperature. A liquid crystal is applied on one end portion of first or second substrates. Then, the first and second substrate are opposed and superimposed at one end portions via the liquid crystal. A press member presses the one end portion while the first stage is moved relative to the press member, so that the press member presses incremental portions of the substrates to make an initial bonding thereof At this moment, the liquid material is extended toward the opposite end portions of the substrates. The bonded substrates are again pressed and heated while the first stage moves relative to the heat member. This causes the incremental portions to be heated and thereby bonded permanently.

This application is based on Japanese Patent Application No. 2000-96676, filed on Mar. 31, 2000, and Japanese Patent Application No. 2000-97523, filed on Mar. 31, 2000, the contents of which are hereby incorporated by reference.

### BACKGROUND OF THE INVENTION

The present invention relates to a method and apparatus for manufacturing a liquid crystal panel.

Generally, a liquid crystal panel includes a pair of spaced substrates each in the form of plate and a liquid crystal filled between the spaced substrates. Also, a sealing material is provided between and along the peripheral opposing edges of the substrates so that it surrounds the liquid crystal. The substrates each bear a number of parallel electrodes on their opposing surfaces so that the electrodes on one substrate extend perpendicular to another electrodes on the other substrate, thereby defining a number of pixels for an image formation, at intersections of the opposing electrodes. If necessary, another layer such as an orientation layer and/or an insulating layer may be provided on the electrodes.

A typical liquid crystal panel of this type is illustrated in FIGS. 7 and 8. The liquid panel 201 includes a pair of flexible lower and upper transparent substrates, 203 and 205, spaced apart from the other. The lower substrate 203 supports, on its upper surface opposing the upper substrate 205, a number of transparent lower electrodes 207 extending parallel in one direction. On the other hand, the upper substrate 205 supports, on its lower surface opposing the lower substrate 203, supports a number of upper electrodes 209 extending parallel in another direction perpendicular to the one direction. Typically, the transparent electrodes 207 and 209 are made of indium-tin oxide (ITO). A liquid crystal 211 is filled between the spaced substrates 203 and 209. The liquid crystal 211 is surrounded by a sealant 213 or sealing material continuously provided between and along the peripheral opposing edges of the substrates 203 and 205. The liquid crystal 211 includes a number of spherical balls or spacers 215 each having a diameter of about five microns so that the opposed substrates 203 and 205 define a constant gap therebetween. If necessary, the lower and upper electrodes 203 and 205 are coated by insulating layers 217 and 219 provided thereon.

The liquid crystal panel 201 is manufactured through a process illustrated in FIGS. 9A to 9I. According to the process, a number of elongated transparent electrodes 209, each having a specific width and leaving a specific distance from the neighboring electrodes, are formed on one surface of the upper substrate 205 (FIG. 9A). If necessary, the electric insulating layer 219, made of silicon oxide for example, is formed on the transparent electrodes 219 by a suitable method such as sputtering (FIG. 9B). Then, the powdery spacers 215 are sprayed onto the layer 219 by the use of a spacer spraying device not shown (FIG. 9C).

The lower substrate 203 is formed on its one surface with a number of elongated transparent electrodes 207, each having a specific width and spacing apart from the neighboring electrodes (FIG. 9D). If necessary, the electric insulating layer 217 is formed on the transparent electrodes 207 (FIG. 9E). Then the sealant 213 is applied on the surface of the lower substrate 203 so that it runs continuously adjacent to and along its peripheral edge by a screen printing for example (FIG. 9F). Examples of the sealant 213 are resins capable of hardening by the exposure of heat or ultraviolet light and thermoplastic resin with a relatively high softening point. Next, an excessive amount of liquid crystal 211 is dropped on one end (right end in the drawing) and within an area surrounded by the sealant 213 (FIG. 9G). The lower substrate 203 supporting the liquid crystal 211 is positioned on a vacuum table 221. The table 221 draws and holds the lower substrate 203 immovably. Then, one end of the upper substrate 215 is placed on the corresponding end of the lower substrate so that the transparent electrodes 207 and 209 intersect with each other (FIG. 9H). The other end of the upper substrate 205 is held above the lower substrate 203. Then, the upper substrate 205 is pressed at its one end toward the lower substrate using a press roller 223 having a longitudinal axis running parallel to the table 221. Then, the table is moved relative to the roller 223, so that the liquid crystal 211 is extended toward the opposite end of the substrate. The gap between the substrates 203 and 205 is maintained constant by the spacers 215. The sealant 213, if it is made of thermoplastic resin, is heated up to its softening point to bond between the lower and upper substrates 203 and 205 (FIG. 9I). For this purpose, it is preferable that the roller 223 includes a heater not shown.

However, the method for manufacturing the liquid crystal panel has several drawbacks. For example, the upper substrate 205 suffers from an excessive force at its bending portion from the roller 223, which may cause cracks or defects in the electrodes of the upper substrate. In particular, an increased tension induced by the roller to avoid the creation of wrinkles in the flexible substrate and the heat applied from the heat roller may cause a number of cracks and defects.

### SUMMARY OF THE INVENTION

In view of above, an object of the present invention is to provide an improved method and apparatus for manufacturing a liquid crystal panel.

Accordingly, according to the method and apparatus for manufacturing a liquid crystal panel, first and second substrates are positioned on first and second stages and then preheated to a certain temperature. A liquid crystal is applied on one end portion of first or second substrates. Then, the first and second substrate are opposed and superimposed at one end portions through the liquid crystal. A press member presses the one end portion while the first stage is moved relative to the press member, so that the press member presses incremental portions of the substrates to make an initial bonding thereof At this moment, the liquid material is extended toward the opposite end portions of the substrates. The bonded substrates are again pressed and heated while the first stage moves relative to the heat member. This causes the incremental portions to be heated and thereby bonded positively.

### BRIEF DESCRIPTION OF THE DRAWINGS

FIG. 1 is a plan view of a liquid crystal panel manufactured by the system of the present invention;

FIG. 2 is an enlarged partial cross sectional view of the liquid crystal panel in FIG. 1;

FIG. 3 is a schematic cross sectional view of the system for manufacturing the liquid crystal panel;

FIGS. 4A to 4H are side elevational views each showing respective processes in the liquid crystal manufacturing method;

FIG. 5 is a schematic cross sectional view of the liquid crystal being manufactured;

FIG. 6 is a schematic perspective view of the liquid crystal being manufactured;

FIG. 7 is a schematic cross sectional view of a conventional liquid crystal panel;

FIG. 8 is a partial perspective view of the conventional liquid crystal panel; and

FIGS. 9A to 9I are partial and whole cross sectional views of the conventional liquid crystal panel, showing a process for manufacturing the liquid crystal panel.

### DETAILED DESCRIPTION OF THE PREFERRED EMBODIMENTS

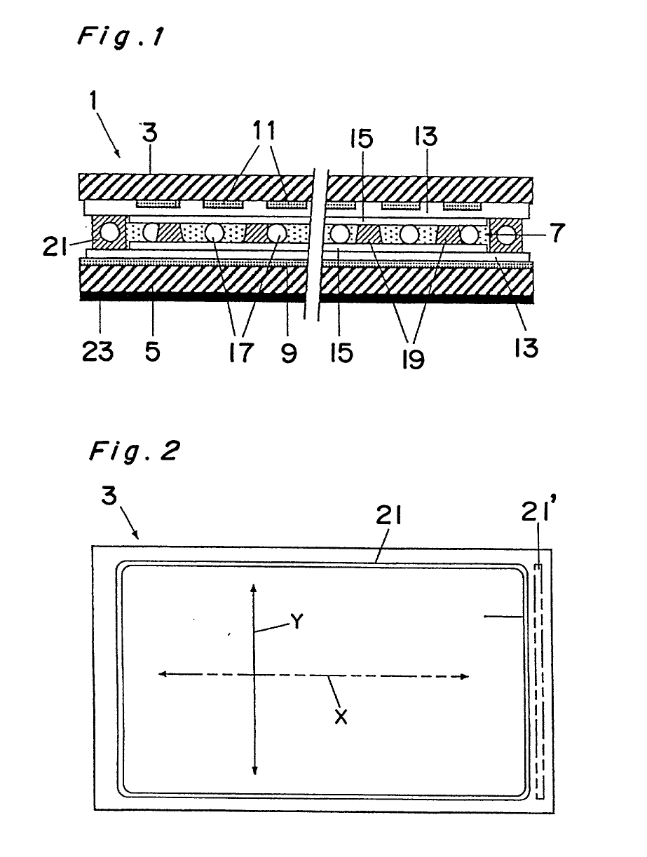

With reference to the drawings, a liquid crystal panel according to the embodiment of the present invention will be described hereinafter. FIGS. 1 and 2 illustrate a reflective liquid crystal panel manufactured by the method and apparatus of the present invention. The liquid crystal panel generally indicated by reference numeral 1 includes a pair of opposing transparent substrates 5 and 3 and a liquid crystal 7 provided between the substrates. Each substrate may be made from flexible transparent film of a suitable material such as polycarbonate (PC), polyethyleneterephthalate (PET), and polyethersulfone (PES). However, the lower substrate may be made from a rigid member such as glass plate. The liquid crystal may be nematic, smectic, discotic, or cholesteric liquid crystal.

Each substrate supports a number of elongated transparent electrodes. For example, the substrate 3 supports, on its surface opposing the substrate 5, a number of elongated electrodes 9 extending parallel in a direction indicated by X, i.e., in a longitudinal direction of the substrate. The other substrate 5 also supports, on its surface opposing the substrate 3, a number of elongated electrodes 11 extending parallel in another direction indicated by Y, i.e., in a transverse direction of the substrate, and perpendicular to the direction X. Each of the substrates 5 and 3 bears an electric insulating layer 13 and also an orientation layer 15 made of polyimide, for example, on its surface opposing the other substrate.

Spacers 17 and columns 19 are also provided in the liquid crystal 7 between the substrates. The spacers 17 are used to define a constant gap between the substrates. For this purpose, the spacer has a certain rigidity capable of resisting pressure or heat. Examples of the material of the spacer are silica, divinylbenzene and acrylic. Preferably, each spacer is coated with a thermoplastic resin. In this instance, the heated spacer makes a permanent adhesion to the substrate. The columns 19 are used to connect between the opposing substrates and also to maintain the constant gap therebetween. Also, a sealing member or wall 21 is provided between and along the peripheral edges of the substrates so that it surrounds the liquid crystal 7.

The columns are made of thermoplastic resin and the sealing wall 21 is made of thermosetting resin. However, this is not restrictive to the present invention. For example, the columns 19 may be made of polyurethane that softens at about 55° C. and fuses at about 140° C., and the sealing wall 21 may be made of epoxy resin that harden in part at about 55° C. and adheres at about 140° C.

Generally, the liquid crystal panel 1 is manufactured through the following process. First, prepared is the transparent substrate 5 made of heat-resisting material such as polycarbonate. The electrodes 9, the insulating layer 13, the orientation layer 15, and then the columns 19 are formed sequentially on the substrate 5. Likewise, the transparent substrate 3 made of heat-resisting material such as polycarbonate is prepared, on which the electrodes 11, the insulating layer 13, and the orientation layer 15 are formed sequentially. Then, the sealing wall 21 and the spacers 17 are provided on the substrate 3. Instead, the spacers 17 may be provided on the other substrate 5. At this stage, the columns 19 and the sealing wall 21 have respective heights slightly greater than that in the resultant liquid crystal panel. The spacers 17 may also be premixed in the material of the sealing wall 21. Also, the substrate 5 has a layer 23 having a black color for absorbing light, on a surface away from the other substrate 3. Further, each of the columns 19 may be separated from or connected with another and have any cross-section such as circle, polygon, and strip. In an atmosphere at a certain temperature of about 140° C., the substrate 3 is placed on the other substrate 5. The substrates 5 and 3 are bonded to each other by the columns 19 and the sealing wall 21.

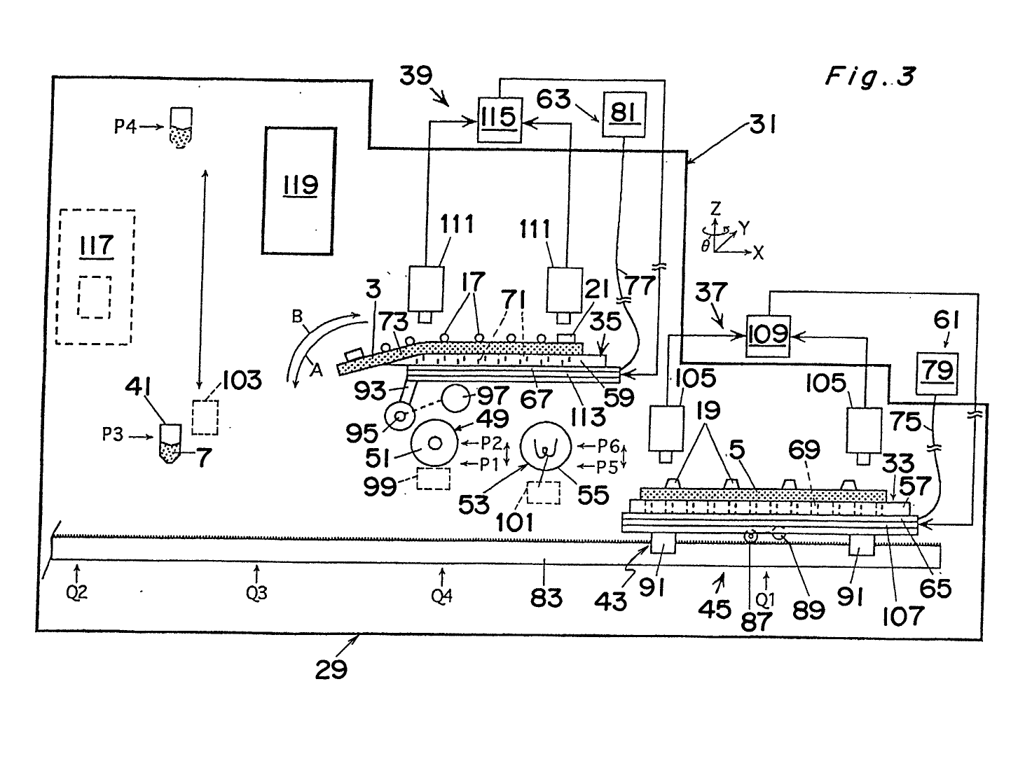

Referring to FIG. 3, a method and system for manufacturing the liquid crystal panel 1 will be described in detail hereinafter. The system generally indicated by reference numeral 29 has a housing 31. The housing 31 includes a first stage 33 for supporting the first substrate 5; a second stage 35 disposed in position relative to the first stage 33 for holding the second substrate 3; a first positioning system 37 for positioning the first substrate 5 in place against the first stage 33; a second positioning system 39 for positioning the second substrate 3 in place against the second stage 35; a liquid-crystal supply 41 for supplying the liquid crystal 7 onto the first substrate 5 retained on the first stage 33; a first drive system 43 (which is a combination of the first drive unit 45 for the first stage 33 and the second drive unit 47 for the second stage 35) for moving the fist and second stages 33 and 35 so that the first and second substrates 5 and 3 are faced to each other and then superimposed at one end thereof; a pressing unit 49 having a pressing member 51 for pressing the superimposed portion of the first and second substrates 5 and 3 toward the first stage 33; a second drive system 45 (which constitutes a part of the first drive system 43 in this embodiment) for moving the first stage 33 relative to the forcing member 51 and the second stage 35 while the second substrate 3 is pulled out of the second stage 35, so that portions of the first and second substrates 5 and 3 are superimposed incrementally on the first stage 33; a heating unit 53 having a heating and pressing member 55 for heating and pressing the superimposed portions of the substrates with the movement of the first stage 33; an exhaust or vacuum unit 117 for vacuuming an interior of the housing 31 down to a certain vacuum; and a pre-heater 119 for heating the interior of the housing 31 and also the substrates 5 and 3.

The vacuum housing 31 has inlet and outlet openings (not shown) for the insertion and extraction of the substrates and doors or closures (also not shown) for sealingly closing the respective openings. The first and second stages 33 and 35 include first and second tables 57 and 59 and vacuum devices 61 and 63, respectively. The first and second tables 57 and 59 have manifold or vacuum chambers 65 and 67 defined therein and a number of through-holes or apertures 69 and 71 defined at top portions thereof for connecting vacuum chambers 65 and 67 with atmosphere for drawing and then retaining the first and second substrates 5 and 3 thereon, respectively. In particular, the second table 59 is formed at its one end portion (i.e., left end portion in FIG. 3) with a ramp 73 or slanted portion so that a portion of the substrate 3 on the ramp is angled to its remaining part on the table 59. The vacuum chambers 65 and 67 are communicated with one ends of passages or tubes 75 and 77 preferably made of flexible material, respectively. Also, the other ends of the tubes 75 and 77 are communicated with vacuum sources 79 and 81, respectively. This allows that, by the operation of the vacuum sources 79 and 81, vacuum is introduced through tubes 75 and 77, the drawing chambers 65 and 67 into the drawing apertures 69 and 71, causing the first and second substrates 5 and 3 to be drawn and then retained on the first and second stages 33 and 35, respectively.

The drive unit 45 of the first stage 33 has a guide rail 83 fixed in the vacuum chamber 8, a rack or gear 85 defined in the guide rail 83, a pinion or gear 87 mounted on the first stage 33 and engaged with the rack 85, and a motor 89 mounted on the first stage 33 and directly or indirectly coupled with the pinion 313 for rotating the pinion 87. With the arrangement, the first stage 33 travels along the guide rail 83 by the driving of the drive unit 45 through a plurality of stations; a first station (positioning station) Q1 where the substrates are positioned in predetermined respective positions on the tables, a second station (liquid-crystal supply station) Q2 where the liquid crystal is supplied onto the first substrate, a third station (contact station) Q3 where the portions of the substrates are brought into contact with each other, and a fourth station (bonding station) Q4 where the superimposed substrates are bonded permanently. Preferably, sliders 91 are provided for the first stage 33 so that they slide on the guide rail 83 with the movement of the first stage 33.

The drive unit 47 of the second stage 35 has a support arm 93. The support arm 93 is supported by a horizontal shaft 95 that is connected with a drive mechanism with a motor 97 fixed in the housing 31, so that by the driving of the motor the shaft 95 together with the second stage 35 is selectively rotated about the shaft 95 in the clockwise (indicated by arrow B) or counterclockwise direction (indicated by arrow A).

The pressing member 51 in the form of cylindrical roller is supported for rotation. Preferably, the pressing roller 51 has a diameter at its opposite end portions that is greater than that of the remaining portion between the end portions. The pressing roller 51 is supported by an elevator unit 99 so that by the driving of the elevator unit 99 it moves up and down between a lowered position P1 where the roller presses the second substrate 3 to the first substrate 5 in the contact region Q3 and an elevated position P2 where the roller spaces away from the substrate.

The heating and pressing member 55 in the form of cylindrical roller is supported for rotation. The roller 55 is also supported by an elevator unit 101 so that by the driving of the elevator system 101 it moves up and down between a lowered position P5 where the roller heats and presses the first and second substrates 5 and 3 in the bonding station Q4 and an elevated position where the roller spaces away from the substrate.

The liquid crystal supply unit 41, which is positioned above the supply station Q2, is supported by an elevator 103 so that by the driving of the elevator 103 the supply unit 41 moves between a lowered position P3 where the unit supplies the liquid crystal 7 onto one end portion of the first substrate 5 in the supply station Q2 and an elevated position P4 where the supply unit spaces away from the substrate.

The positioning system 37, which is positioned above the positioning station Q1, has two imaging devices or cameras 105 for the recognition of the horizontal position and angular orientation of the substrate 5. Preferably the cameras are CCD cameras. For this purpose, the substrate 5 is provided with indications marked on its top surface, which will be recognized by the cameras 105 for the alignment of the substrate 3. The positioning system 37 has an X-Y-0 drive unit 107 for moving the substrate horizontally, i.e., in one direction (X-direction) and another direction (Y-direction) perpendicular to the one direction, to correct the position of the substrate 3 and for rotating the substrate about a vertical axis not shown to correct the angular orientation (θ) of the substrate. The cameras 105 and the X-Y-θ drive unit 107 are electrically connected with an X-Y-θ controller 109 so that the controller 109 receives a signal indicative of the position of the substrate from the cameras 105 and, based on the signal, drives the drive unit 107 to correct the horizontal and angular position of the substrate, if necessary.

Another positioning system 39 for the second substrate 3 is positioned above the second stage 35 that takes the face-up position shown in FIG. 3. The device 39 includes two imaging devices or CCD cameras 111 for the recognition of the horizontal position and angular orientation of the substrate 3. For this purpose, the substrate 3 is provided with indications marked on its surface opposing the cameras 111, which will be recognized by the cameras 111 for the alignment of the substrate 3. The positioning system 39 has an X-Y-θ drive 113 for moving the substrate horizontally, i.e., in one direction (X-direction) and another direction (Y-direction) perpendicular to the one direction, to correct the position of the substrate 3 and for rotating the substrate about a vertical axis not shown to correct the angular orientation (θ) of the substrate. The cameras 111 and the X-Y-θ drive 113 are electrically connected with an X-Y-θ controller 115 so that the controller 115 receives a signal indicative of the position of the substrate from the cameras 111 and, based on the signal, drives the drive 113 to correct the horizontal and angular position of the substrate, if necessary.

In order to avoid an interference between the substrate 3 and/or stage 35 with the cameras 111, the cameras 111 are supported by an elevator not shown so that, after the recognition of the substrate 3 they moves away from a rotational pass of the substrate and stage.

The positioning systems 37 and 39 ensures that the substrates 5 and 3 are superimposed and then bonded to each other at respective stations without any misalignment between them.

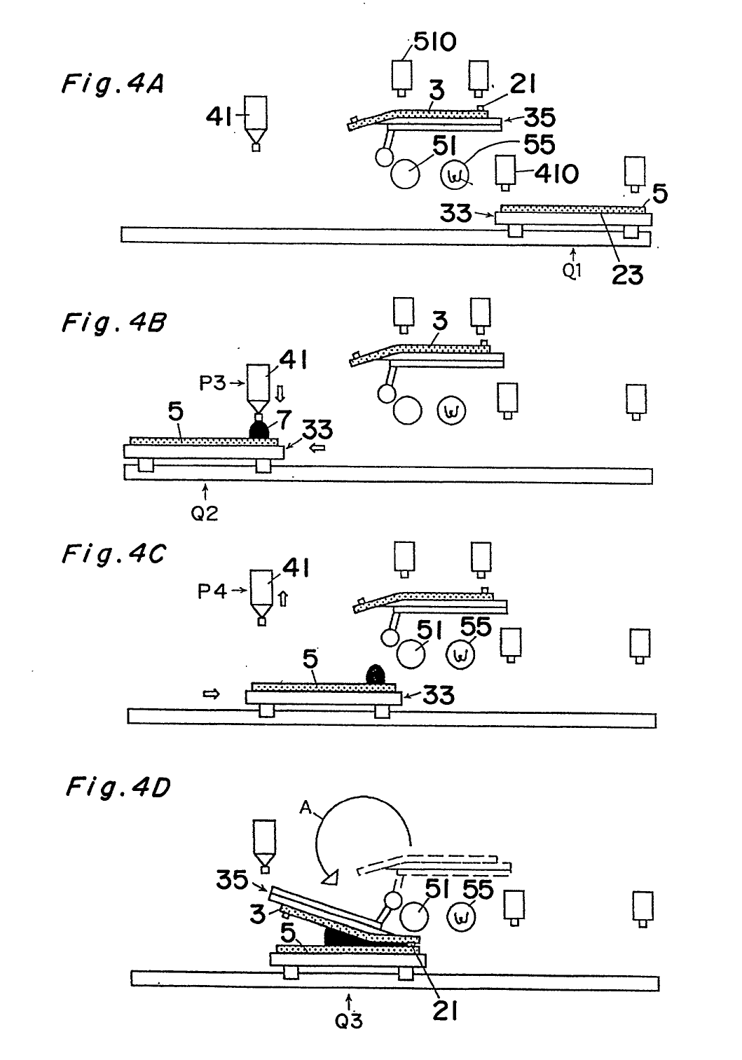

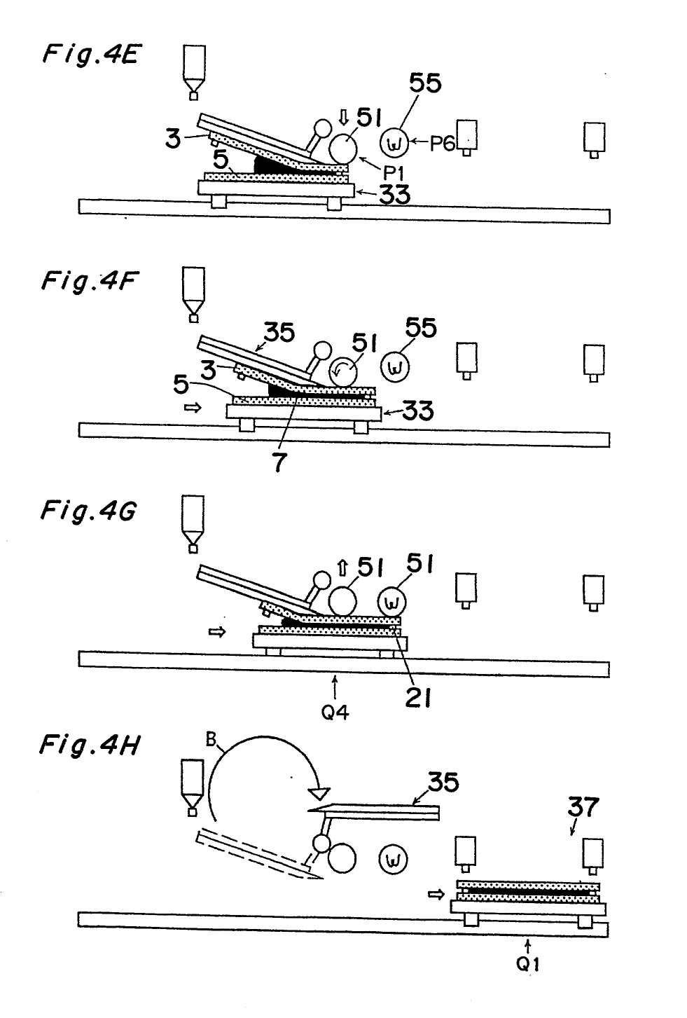

Referring to FIGS. 4A through 4H, operations for manufacturing the reflective liquid crystal display panel shown in FIGS. 1 and 2 will be described hereinafter.

Before stating the processes described below, two substrates 5 and 3 with electrodes 9 and 11, insulating layers 13 and orientation layers 15, respectively, are provided. Also, the columns 19 are formed on the first substrate 5, and the spacers 17 are sealing wall 21 are provided on the second substrate 3.

As shown in FIG. 4A, the first substrate 5, with its surface supporting the columns 19 faced up, is placed on the first stage 33 and then held by the vacuum derived from the vacuum source 79. Likewise, the second substrate 3, with its surface supporting the spacers 17 and sealing wall 21 faced up, is placed on the second stage 35 and then held by the vacuum derived from the vacuum source 81. In particular, as can be seen from the drawing, one end portion (i.e., left end portion) of the substrate 3 may be extended out of the ramp 201 of the table 59. The misalignments of the substrates 5 and 3 are corrected by the positioning systems 37 and 39, respectively. After the recognition or positioning in the positioning system 39, the recognition cameras 111 are elevated away from the rotational pass of the stage 35.

The interior of the housing 31 is vacuumed by the vacuum source 117 down to about 13-40 Pa (substantially equal to about 0.1-0.3 Torr). The vacuum pressure is not limited thereto. Also, the heater 119 is energized to increase the temperature of the interior in the housing 31, heating the substrates up to about 55° C.

Referring to FIG. 4B, the drive unit 45 is activated so that the first stage 33 with the first substrate 5 is transported to the liquid-crystal supply station Q2. The supply unit 41 moves down to its lowered position P3 where it supplies the liquid crystal onto one end portion (i.e., right end portion) of the substrate 3. In order to ensure a formation of an even liquid crystal layer on the substrate in the subsequent process, the liquid crystal is preferably extended across the substrate in its transverse direction.

Referring next to FIG. 4C, the supply unit 41 is elevated away from the supply station Q2 to its elevated position P4. After the completion of the elevating operation of the supply unit or immediately after the beginning of the elevation, the drive unit 45 is activated again to transport the first stage 33 with the substrate 5 into the contact region Q3 where the liquid crystal on the substrate positions under the forcing roller 51.

Referring next to FIG. 4D, the drive unit 47 is activated to rotate the second stage 35 with the second substrate 3 in the direction A, so that the one end portion of the second substrate 3 supported on or extended out of the ramp 73 of the table 59 is opposed to the one end portion of the first substrate 5 supporting the liquid crystal under the roller 51. At this stage, the second substrate 3 may or may not make contact with the liquid crystal on the first substrate 5.

Thereafter, as shown in FIG. 4E, the roller 51 is moved down, so that the opposing end portions of the substrates 5 and 3 are pressed and thereby bonded temporally to each other on the stage 33. This results in that the excessive portion of the liquid crystal is pressed and then extended toward the opposite end of the separated portions of the substrates.

Then, as shown in FIG. 4F, the drive unit 45 drives to move the first stage 33 back toward the positioning station Q1. At this moment, the second stage 35 is retained in the lowered position. The roller 51 is also retained in the lowered position so that it continues to press one end portion of the second substrate 3 to the first substrate 5 on the table 57. Also, the roller 51 is free to rotate with the movement of the substrate 3. Therefore, according to the movement of the first stage 33, a frictional force and the adhesion between the first and second substrates 5 and 3 causes the second substrate 3 move relative to and slide on the second table 59 toward the positioning station. In this movement of the second substrate 3, incremental portions thereof are brought into contact with the corresponding portions of the first substrate 5 as it forces and extends the liquid crystal remaining at the V-shaped corner, i.e., contacting region, toward the tailing end of the substrates. In this process, the pressed liquid crystal flows smoothly on the substrate 5 along the electrodes extending in the same direction, which prevents the liquid crystal from flowing beyond the sealing walls extending in the longitudinal direction. On the other hand, a remaining portion of the second substrate 3 on the table 59 is well retained by the vacuum applied thereto through apertures 71 by the vacuum source 81.

Referring next to FIG. 4G, the bonded portions of the substrates 5 and 3 are further transported toward the positioning station. When the leading end portion of the bonded substrates 5 and 3 arrives at a heat position, the heat roller 55 takes the lowered position P5 to contact with the leading end portion. The portion where the heat roller 55 begins to contact with the substrate may be another portion of the substrate adjacent the leading end 21′ (see FIG. 2) of the sealing wall 21. The heat roller 55 presses the incremental portions of the substrates 5 and 3 at the heat position. Simultaneously with this, the substrates are heated by the heat roller 55 at about 140° C. This fuses the sealing wall 21 and the columns 19 to provide a permanent bonding of substrates 5 and 3. The fused sealing wall 21 and columns 19 have a predetermined height that is equal to the diameter of the spacers. For this heating, the heater incorporated in the roller 55 should be preheated well in advance before the contact with the substrate.

Referring next to FIG. 4H, after the completion of the temporal and permanent bonding of the tailing end portions of the substrates 5 and 3, the rollers 51 and 55 are elevated away from the temporal and permanent bonding positions, respectively.

Subsequently, the vacuum sources 79 and 81 are de-energized to eliminate the vacuum in the apertures, allowing the resultant panel to be removed from the substrate. Then, the second stage 35 is rotated in the direction B to take the position shown in FIG. 3 for the next bonding of the substrates.

The resultant panel removed from the housing is then cooled down to the atmospheric temperature, so that the cooled sealing wall and columns provide a permanent fixing between the substrates.

As described above, the first substrate 5 on the stage 33 takes a predetermined position in the housing. Also, the second substrate 3 takes another predetermined position in the housing. The two predetermined positions have a predetermined, positional relationship. This allows the substrates 5 and 3 to be superimposed without any misalignment.

Also, the substrates 5 and 3 are preheated well in advance before they are superimposed. This prevents the generation of wrinkles and/or voids in the substrates, which would be caused due to the whole or partial bad heating of either or both of the substrates. For the preheating of the substrates, a heater may be provided in the tables. This reduces a time for heating the substrate considerably.

Further, in the process for placing the second substrate 3 onto the first substrate 5, the leading end portion of the substrate 3 is superimposed on the corresponding portion of first substrate 5. Then, the superimposed portion is moved by the movement of the first stage 33 relative to the roller 51 as it is pressed by the roller 51. This causes the liquid crystal between the substrates is extended continuously toward tailing end portions of the substrates, which forces bubbles out of the liquid crystal and also prevents atmospheric air from being captured in the liquid crystal. This in turn prevents and, if any, minimizes the existence of unwanted air in the resultant panel. Further, the substrates 5 and 3 are preheated before the permanent bonding thereof This minimizes a thermal shock to the substrates and allows the substrates to be bonded at an elevated temperature without any trouble.

Furthermore, in the embodiment in which the roller 55 makes a first contact with the portion of the substrate adjacent the sealing wall, the existence of the sealing wall 21 prevents an excessive heat expansion of each of the substrates 5 and 3 and thereby the generation of wrinkles of the substrates and also prevents the generation of voids in the liquid crystal.

Therefore, as shown in FIG. 2, another wall 21′ extending in the transverse direction of the panel may be provided immediately outside the sealing wall 21. Preferably, the wall 21′ is made of the same material as the sealing wall 21. This allows that, by the initiation of the heating of substrate on the wall 21′, the same effect, i.e., the prevention of the wrinkles and voids, can also be attained.

Moreover, the leading end portions of the substrates may be connected mechanically by a suitable member so as to ensure that the substrates move together without causing any misalignment therebetween. For example, according to the embodiment shown in FIG. 5, the leading end portions of the substrates are connected by one or more pins 131. The pin 131 is retained at its one end by the table 57 and extended vertically. The substrates, on the other hand, are formed with corresponding through-holes 133 and 135. With the arrangement, the first substrate 5 is placed on the table 57 so that its through-hole 133 receives the pin 131. Then, when the leading end portion of the second substrate 3 is positioned on the corresponding leading portion of the first substrate 5, the through-hole 135 receives the pin 131, which ensures that the second substrate 3 is held immovably on the first substrate 5. To prevent the rollers from being damaged, the pin 131 may be supported for movement in the vertical direction so that it is forced down by the contact with the rollers 49 and 55. For this purpose, as shown in FIG. 5, the pin 131 is supported in a hole 137 in which a spring 139 is received for supporting the lower end of the pin.

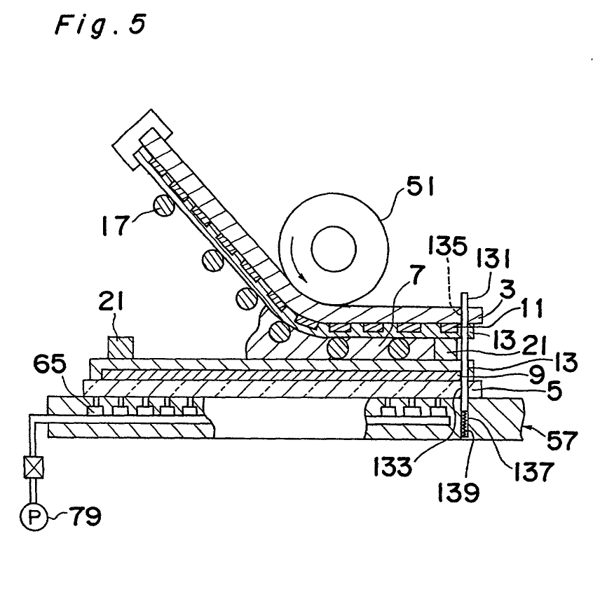

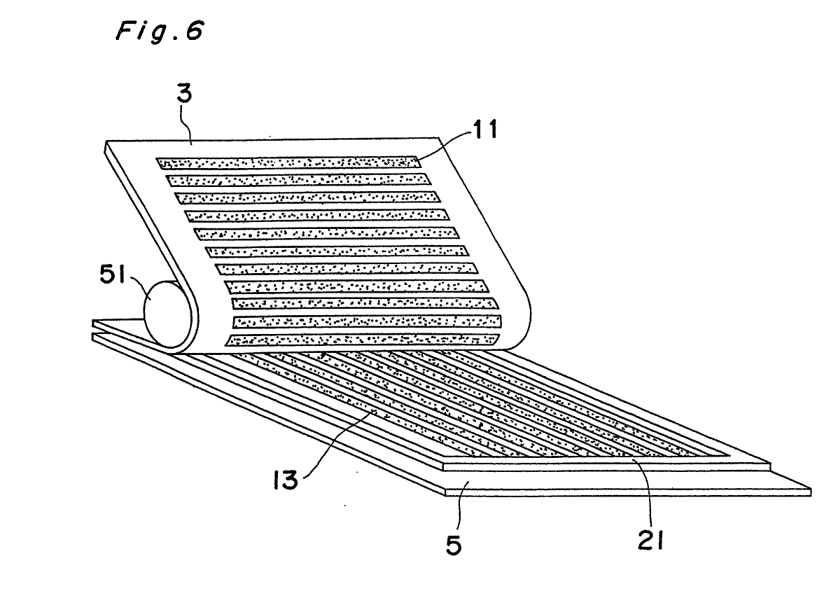

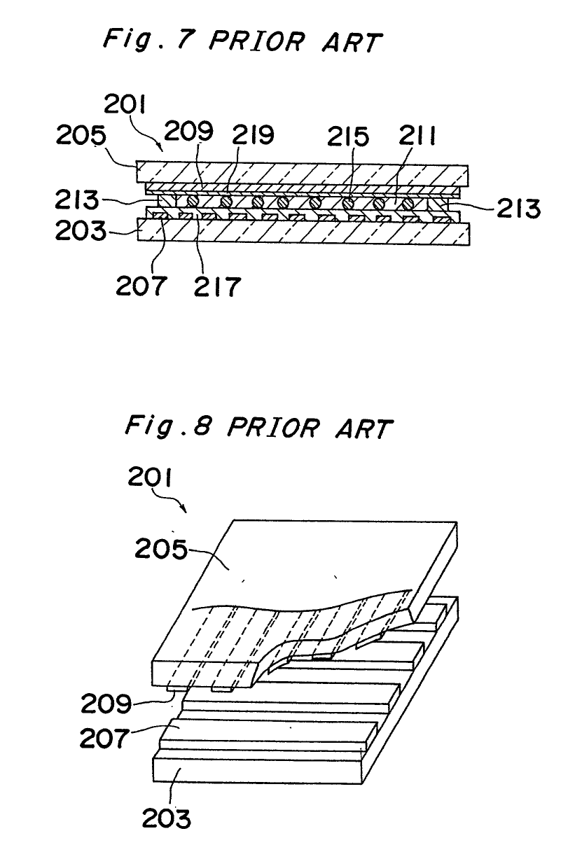

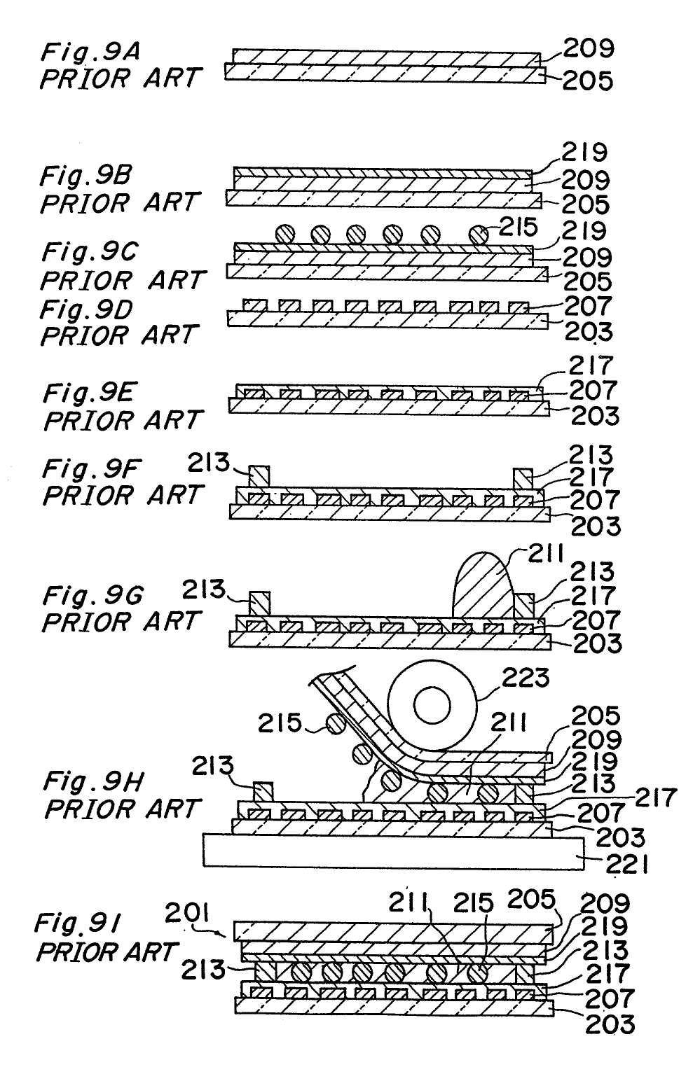

As best shown in FIG. 6, the substrate 3 is superimposed so that the extending direction of the electrode 11 is parallel to the axial direction of roller 51 SO that unnecessary load is applied to the electrodes at the bending portion. Therefore, no cracking or some defect would occur to the electrodes 11 without careful settings of bending angle, bending curvature, and pressure force of the roller 51. In this regard, experimental examples and comparative examples are described below.

### EXAMPLE 1

Prepared were two substrates made of PES with ITO film coating, commercially available from Sumitomo Bakelite. Using lithography, a number of parallel electrodes each having a width of 125 microns and leaving a gap of 15 microns therebetween on the substrates. Using screen printing, the sealing wall of polyester was printed on one of two substrates. Spacers each having a diameter of 6 microns were sprayed on the other substrate.

The two substrates were superimposed without any existence of the liquid crystal by using the vacuum table and the roller having a diameter of 20 mm, as shown in FIG. 5. One substrate positioned on the fixed table was oriented to direct its electrodes perpendicular to the roller while the other substrate was oriented to direct its electrodes parallel to the roller. An angle defined between the substrates at the bonding region was set to be 30°. The roller pressure applied to the substrates was about 2.0×10⁴ N/m². The roller was heated at 150° C., which corresponds to a melting point of polyester forming the sealing wall.

As a result, no crack was detected in the substrates.

### COMPARATIVE EXAMPLE 1

For comparison, one substrate positioned on the fixed table was oriented to direct its electrodes parallel to the roller while the other substrate was oriented to direct its electrodes perpendicular to the roller. Other conditions were the same as those in the Example 1. As a result, a number of cracks were detected in the upper electrodes.

### EXAMPLE 2

The liquid crystal was supplied onto the lower substrate as described in FIG. 5. Other conditions were the same as those in the Example 1. As a result, only a small amount of liquid crystal flowed beyond the side sealing walls.

### COMPARATIVE EXAMPLE 2

The liquid crystal was supplied onto the lower substrate as described in FIG. 5. Other conditions were the same as those in the Comparative Example 1. As a result, a large amount of liquid crystal flowed beyond the side sealing walls. Therefore, a larger amount of liquid crystal was needed for manufacturing the panel than Example 2.

In conclusion, according to the system and method for manufacturing the liquid crystal panel of the present invention, the substrates with spacers and columns therebetween are well positioned relative to each other and bonded to each other without any generation of wrinkles in the substrates or voids in the liquid crystal.

Although the present invention has been fully described for the reflective liquid crystal panel, it may be applied equally to the transmission liquid crystal panel. In this instance, no light absorbing layer is necessary for a transmission panel.

What is claimed is:

1. A method for manufacturing a liquid crystal panel, the liquid crystal panel comprising a first substrate having first and second surfaces; a second substrate having third and fourth surfaces, the first and second substrates being positioned so that the first surface of the first substrate opposes the third surface of the second substrate; a liquid crystal layer disposed between the opposed first and second substrates, the liquid crystal layer having a liquid crystal, spacers, and columns; and a sealing wall provided between the first and second substrates and extending around the liquid crystal layer; said method comprising the steps of:
providing the columns, spacers, and sealing wall on at least one of the first surface of the first substrate and the third surface of the second substrate;
positioning the first substrate on a first stage so that the second surface of the first substrate opposes the first stage;
positioning the second substrate on a second stage so that the fourth surface of the second substrate opposes the second stage;
preheating the first and second substrates to a predetermined preheating temperature;
applying a liquid crystal on one end portion of either the first surface of the first substrate positioned on the first stage or the third surface of the second substrate positioned on the second stage;
opposing the first and second stages so that the first surface of the preheated first substrate faces the third surface of the preheated second substrate;
superimposing the one end portion of the first surface of the first substrate onto the corresponding one end portion of the third surface of the second substrate via the liquid crystal;
pressing a press member on one end portion of the fourth surface of the second substrate, corresponding to the one end portion of the third surface of the second substrate, while said second substrate is superimposed on the first substrate;
providing relative movement between the first stage and the press member so that the press member presses incremental portions of the first and second substrates to make an initial bonding of the first and second substrates while extending the liquid crystal in an entire area surrounded by the sealing wall;
pressing a heat member on the thus initially bonded one end portion of the fourth surface of the second substrate; and
providing relative movement between the first stage and the heat member so that the heat member heats incremental portions of the first and second substrates up to a temperature higher than the preheating temperature to make a final bonding of the first and second substrates.

2. A method in accordance with claim 1, wherein the step of pressing a heat member is initiated at a portion adjacent the sealing wall.

3. A method in accordance with claim 1, further comprising forming another wall at one end of the first surface of the first substrate or the third surface of the second substrate adjacent to and outside of the sealing wall;
wherein the steps of pressing a heat member and providing relative movement between the first stage and the heat member are initiated at a portion adjacent to said another wall.

4. A method in accordance with claim 1, wherein the preheating is performed by heating an atmosphere around the first and second substrates up to the preheating temperature.

5. A method in accordance with claim 1, wherein the preheating is performed by heaters provided to the first and second substrates, respectively.

6. A method in accordance with claim 1, wherein the press member is a roller supported for rotation to follow a movement of the second substrate, the roller having a first diameter at opposite end portions thereof and a second diameter at a portion between the opposite end portions, the first diameter being greater than the second diameter.

7. A method in accordance with claim 1, wherein the initial and final bonding of the substrates are performed in vacuum.

8. A method for manufacturing a liquid crystal panel, the liquid crystal panel comprising a first substrate having first and second surfaces; a second substrate having third and fourth surfaces, the first and second substrates being positioned so that the first surface of the first substrate opposes the third surface of the second substrate; a liquid crystal layer disposed between the opposed first and second substrates, the liquid crystal layer having a liquid crystal, spacers, and columns; and a sealing wall provided between the first and second substrates and extending around the liquid crystal layer; said method comprising the steps of:
providing the columns, spacers and sealing wall on at least one of the first surface of the first substrate and the third surface of the second substrate;
positioning the first substrate on a first stage so that the second surface of the first substrate opposes the first stage;
positioning the second substrate on a second stage so that the fourth surface of the second substrate opposes the second stage;
applying a liquid crystal on one end portion of either the first surface of the first substrate positioned on the first stage or the third surface of the second substrate positioned on the second stage;
opposing the first and second stages so that the first surface of the first substrate faces the third surface of the second substrate;
superimposing the one end portion of the first surface of the first substrate onto the corresponding one end portion of the third surface of the second substrate via the liquid crystal;
pressing a press member on one end portion of the fourth surface of the second substrate, corresponding to the one end portion of the third surface of the second substrate, while said second substrate is superimposed on the first substrate;
providing relative movement between the first stage and the press member so that the press member presses incremental portions of the first and second substrates to make an initial bonding of the first and second substrates while extending the liquid crystal in an entire area surrounded by the sealing wall;
pressing a heat member, at a certain pressure and temperature, on the thus initially bonded one end portion of the fourth surface of the second substrate; and
providing relative movement between the first stage and the heat member so that the heat member heats incremental portions of the first and second substrates to make a final bonding of the first and second substrates;
wherein the step of pressing a heat member is initiated at a portion adjacent the sealing wall.

9. A method in accordance with claim 8, wherein the press member is a roller supported for rotation to follow a movement of the second substrate, the roller having a first diameter at opposite end portions thereof and a second diameter at a portion between the opposite end portions, the first diameter being greater than the second diameter.

10. A method in accordance with claim 8, wherein the initial and final bonding of the substrates are performed in vacuum.

11. A method for manufacturing a liquid crystal panel, the liquid crystal panel comprising a first substrate having first and second surfaces; a second substrate having third and fourth surfaces, the first and second substrates being positioned so that the first surface of the first substrate opposes the third surface of the second substrate; a liquid crystal layer disposed between the opposed first and second substrates, the liquid crystal layer having a liquid crystal, spacers, and columns; and a sealing wall provided between the first and second substrates and extending around the liquid crystal layer; said method comprising the steps of:
providing the columns, spacers, and sealing wall on at least one of the first surface of the first substrate and the third surface of the second substrate;
positioning the first substrate on a first stage so that the second surface of the first substrate opposes the first stage;
positioning the second substrate on a second stage so that the fourth surface of the second substrate opposes the second stage;
applying a liquid crystal on one end portion of either the first surface of the first substrate positioned on the first stage or the third surface of the second substrate positioned on the second stage;
opposing the first and second stages so that the first surface of the first substrate faces the third surface of the second substrate;
superimposing the one end portion of the first surface of the first substrate onto the corresponding one end portion of the third surface of the second substrate via the liquid crystal;
pressing a press member on one end portion of the fourth surface of the second substrate, corresponding to the one end portion of the third surface of the second substrate, while the second substrate is superimposed on the first substrate;
providing relative movement between the first stage and the press member so that the press member presses incremental portions of the first and second substrates to make an initial bonding of the first and second substrates while extending the liquid crystal in an entire area surrounded by the sealing wall;
pressing a heat member, at a certain pressure and temperature, on the thus initially bonded one end portion of the fourth surface of the second substrate; and
providing relative movement between the first stage and the heat member so that the heat member heats incremental portions of the first and second substrates to make a final bonding of the first and second substrates;
wherein the step of pressing a heat member is initiated at a portion adjacent to an another wall formed adjacent to and outside of the sealing wall.

12. A method in accordance with claim 11, wherein the press member is a roller supported for rotation to follow a movement of the second substrate, the roller having a first diameter at opposite end portions thereof and a second diameter at a portion between the opposite end portions, the first diameter being greater than the second diameter.

13. A method in accordance with claim 11, wherein the initial and final bonding of the substrates are performed in vacuum.

14. An apparatus for use in manufacturing a liquid crystal panel, the liquid crystal panel including a first substrate having first and second surfaces; a second substrate having third and fourth surfaces, the first and second substrates being positioned so that the first surface of the first substrate opposes the third surface of the second substrate; a liquid crystal layer disposed between the opposed first and second substrates, the liquid crystal layer having a liquid crystal, spacers, and columns; and a sealing wall provided between the first and second substrates and extending around the liquid crystal layer; said apparatus comprising:
a first stage for supporting the second surface of the first substrate;
a first positioning means for positioning the first substrate on the first stage;
a second stage for supporting the fourth surface of the second substrate;
a second positioning means for positioning the second substrate on the second stage;
a pre-heater for preheating the first and second substrates at a predetermined preheating temperature;
an applicator for applying the liquid crystal on one end portion of either the first substrate positioned on the first stage or the second substrate positioned on the second substrate;
a first drive for moving the first and second stages so that the first substrate on the first substrate opposes the second substrate on the second substrate and the one end portion of the first substrate is superimposed on the corresponding one end portion of the second substrate via the liquid crystal applied by the applicator;
a press member for pressing the superimposed one end portions of the first and second substrates to the first stage;
a second drive for providing relative movement between the first stage and the press member on condition that the first and second substrates are held by the press member and the first stage so that the first and second substrates are sequentially bonded from the one end portions thereof toward opposite end portions thereof while the liquid crystal is extended toward the opposite end portions of the first and second substrates, and
a heat and press member, mounted for movement relative to the first stage, for heating the bonded portions of the first and second end portions of the substrates at a temperature higher than the preheating temperature and simultaneously pressing the bonded portions toward the first stage.

15. An apparatus in accordance with claim 14, wherein the pre-heater has a heater provided in the first stage for heating the first substrate and another heater provided in the second stage for heating the second substrate.

16. An apparatus in accordance with claim 14, wherein the pre-heater is a heater for heating an atmosphere around the first and second stages.

17. An apparatus in accordance with claim 14, wherein the press member is a roller supported for rotation to follow a movement of the substrates, the roller having a first diameter at opposite end portions thereof and a second diameter at a portion between the opposite end portions, the first diameter being greater than the second diameter.

18. An apparatus in accordance with claim 14, further comprising a vacuum housing in which the bonding of the first and second substrates can be performed in vacuum.

19. A method for manufacturing a liquid crystal panel, comprising the steps of:
positioning a lower substrate on a stage;
applying a liquid crystal on the lower substrate;
providing an upper substrate so as to oppose the first substrate, a surface of the upper substrate opposing the lower substrate bearing a number of elongated electrodes each extending in one direction;
causing a roller, which has a longitudinal axis extending parallel to the electrodes, to press the upper substrate against the lower substrate; and
moving the stage with the lower and upper substrates relative to the roller in another direction perpendicular to the one direction so that incremental portions of the lower and upper substrates are bonded to each other and also the liquid crystal is extended between the lower and upper substrates.

20. A method in accordance with claim 19, wherein the lower substrate has a surface opposing the upper substrate, the surface bearing a number of elongated electrodes each extending in said another direction.

21. A method in accordance with claim 19, further comprising:
before the step of moving, positioning one end portion of the upper substrate with respect to said another direction on a corresponding one end portion of the lower substrate with respect to said another direction; and
while moving the stage with the lower and upper substrates relative to the roller, retaining an opposite end portion of the upper substrate away from a corresponding opposite end portion of the lower substrate.

22. A method for manufacturing a panel having a pair of opposed substrates, said method comprising the steps of:
positioning a lower substrate on a stage;
providing an upper substrate so that it opposes the first substrate, a surface of the upper substrate opposing the lower substrate bearing a number of elongated electrodes each extending in one direction;
causing a roller, which has a longitudinal axis extending parallel to the electrode, to press the upper substrate against the lower substrate; and
moving the stage with the lower and upper substrates relative to the roller in another direction perpendicular to the one direction so that incremental portions of the lower and upper substrates are bonded to each other.

23. A method in accordance with claim 22, wherein the lower substrate has a surface opposing the upper substrate, the surface bearing a number of elongated electrodes each extending in said another direction.

24. A method in accordance with claim 22, further comprising:
before the step of moving, positioning one end portion of the upper substrate with respect to said another direction on a corresponding one end portion of the lower substrate with respect to said another direction; and
while moving the stage with the lower and upper substrates relative to the roller, retaining an opposite end portion of the upper substrate away from a corresponding opposite end portion of the lower substrate.
